(19) United States
(12) Patent Application Publication
(10) Pub. No.: US 2010/0242245 A1
(43) Pub. Date: Sep. 30, 2010

(54) SUBMERGED NOZZLE SUPPORTING-REPLACING MECHANISM

(76) Inventors: Kenji Yamamoto, Tokyo (JP); Mototsugu Osada, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/677,936

(22) PCT Filed: Jan. 5, 2009
(86) PCT No.: PCT/JP2009/050003

§ 371 Date: Mar. 12, 2010

(30) Foreign Application Priority Data
Jan. 16, 2008 (JP) 2008-006797
Mar. 3, 2008 (JP) 2008-051799

(51) Int. Cl. B25B 27/14

(52) U.S. Cl. 29/281.1

(57) ABSTRACT

To regulate a position of each of clampers by setting an entire width dimension of each of the clampers to be smaller than a flange diameter dimension of a submerged nozzle and to smooth replacement of a fresh submerged nozzle by providing a positioning liner, to thereby obtain a simple structure at a low cost, provided is a submerged nozzle supporting-replacing mechanism, which is constituted to set an entire width dimension (L3) of each of clampers (20 and 21) to be smaller than a flange diameter dimension (L1) of a submerged nozzle (9) so as to position each of the clampers (20 and 21) by a positioning member (26), and so as to guide an upper surface (43) of a fresh submerged nozzle (9A) by a positioning liner (6), to thereby regulate a height position of the fresh submerged nozzle (9A) during movement in a horizontal direction thereof.

### TECHNICAL FIELD

The present invention relates to a submerged nozzle supporting-replacing mechanism. In particular, the present invention relates to a novel improvement for regulating a position of each of clampers by a positioning member by setting each of entire width dimensions of the clampers to be smaller than a flange diameter dimension of a submerged nozzle, and for achieving a simple and low-cost structure and a reduction in size and weight of a fire-proof object by regulating a height position of a fresh submerged nozzle by a positioning liner.

### BACKGROUND ART

As a submerged nozzle supporting-replacing mechanism of this type, which has been conventionally used, there are exemplified structures described in Patent Documents 1 to 3, for example.

That is, in a first conventional example described in Patent Document 1, a joint plane of an upper fire-proof object, with which a submerged nozzle comes into contact, is set to be larger than a joint plane of the submerged nozzle. A fresh submerged nozzle for replacement is arranged below a joint surface of the upper fire-proof object at an inserting position. When the fresh submerged nozzle is caused to slide for replacement, the fresh submerged nozzle is caused to slide up to a tapping hole while being pressed through oscillating levers against the joint surface of the upper fire-proof object.

Further, a plurality of oscillating levers are arranged within the substantially same width as that of a submerged-nozzle upper-flange.

Further, in a second conventional example described in Patent Document 2, a fresh submerged nozzle is provided with a pressing-force biasing mechanism so as not to come into contact with its upper nozzle during movement from the inserting position to a casting position. The biasing mechanism is provided with a slide frame with a purpose of adjusting a height position of a keyboard, which presses the submerged nozzle. The slide frame moves correspondingly to movement of the fresh submerged nozzle so as to adjust the height of each of a plurality of keyboards. Thus, a structure is obtained, in which the submerged nozzle does not come into contact with the upper nozzle.

Further, in this case, joint surfaces of the submerged nozzle and the upper fire-proof object are designed so as to be the substantially same in size.

The mechanism causes the fresh submerged nozzle to move up to the tapping hole so as not to come into contact with the upper fire-proof object, with a purpose of not damaging the joint surface of the fresh submerged nozzle.

Further, in a third conventional example described in Patent Document 3, the fresh submerged nozzle is provided with an oscillating arm, which is biased by a pressing means so as not to come into contact with its upper nozzle during movement from the inserting position to the casting position. The oscillating arm controls, with first and second protrusions, a slide position, a height position, and a pressing force of the submerged nozzle retained in a submerged-nozzle retaining case.

Further, in this case, joint surfaces of the submerged nozzle and the upper fire-proof object are designed so as to be the substantially same in size.
Patent Document 1: Japanese Utility Model Registration No. 3009112 A
Patent Document 2: JP 3781371 B
Patent Document 3: JP 3834741 B

### DISCLOSURE OF THE INVENTION

### Problems to be Solved by the Invention

The conventional submerged nozzle supporting-replacing mechanisms are structured as described above, and hence there are the following problems.

That is,

### (1) In the First Conventional Example,

it is necessary to enlarge the joint surface of the upper fire-proof object, with which the submerged nozzle comes into contact, and hence the fire-proof object increases in weight, which leads a low workability. Further, the weight thereof is heavy and the joint surface is large. As a result, in order to ensure a plane accuracy during a manufacturing process, the fire-proof object increases in cost.

### (2) In the Second Conventional Example and the Third Conventional Example

the pressing force biasing mechanism for controlling movement of the submerged nozzle is complicated, and apparatus cost is high. Further, there is a defect in that maintenance cost also increases.

### Means for Solving the Problems

A submerged nozzle supporting-replacing mechanism according to the present invention includes: first and second clampers, which are provided on a side of a lower frame of a slide valve device controlling a flow rate of molten metal from a tundish to a mold, and are located on both sides of a submerged nozzle so as to press the submerged nozzle during casting against an upper fire-proof object; a spring provided to a supporting protrusion of the lower frame, for upwardly biasing each of the clampers; two pairs of guide rails provided to a frame on the side of the lower frame, for guiding movement in a horizontal direction of the submerged nozzle; and an extruding device for pushing the submerged nozzle in the horizontal direction, in which: an entire width dimension of each of the first and second clampers is set to be smaller than a flange diameter dimension of a flange of the submerged nozzle; a positioning member, which is provided so as to be suspended from the supporting protrusion, is engaged to the first and second clampers so as to position each of the clampers; and a positioning liner, which is provided on a lower surface of the lower frame, guides an upper surface of a subsequent and fresh submerged nozzle replacing the submerged nozzle, to thereby regulate a height position of the fresh submerged nozzle during movement in the horizontal direction of the fresh submerged nozzle. Further, each of clamper pieces of the first and second clampers is axially supported through a pin, the positioning member passes through a through-hole formed in a rear portion of each of the clamper pieces, and an enlarged portion, which is formed at a tip of the positioning member, is engaged to the rear portion. Further, a clamper center, which indicates a width center of the entire width dimension of each of the first and second clampers, is corresponding to a flange center, which indicates a width center of the flange diameter dimension. Between the flange diameter dimension and a first arranging width measured from the clamper center up to an upstream end on an upstream side, a relation of L1:L2=1:0.2 to 0.4 is set. Further, a tip end upper portion of each of the clamper pieces of the first and second clampers is shaped into a curved-surface-shape including a predetermined arc. Further, of the respective clamper pieces of the first and second clampers, a tip end upper portion of only each of the clamper pieces located on a most deeply inserting side or tip end upper portions of all the clamper pieces are shaped into an inclined-surface-shape. Further, a submerged nozzle supporting-replacing mechanism includes: first and second clampers, which are provided on a downstream side of a stopper device controlling a flow rate of molten metal from a tundish to a mold, and are located on both sides of a submerged nozzle so as to press the submerged nozzle during casting against an upper fire-proof object; a spring provided to a supporting protrusion of the lower frame, for upwardly biasing each of the clampers; two pairs of guide rails provided to a frame on a side of the lower frame, for guiding movement in a horizontal direction of the submerged nozzle; and an extruding device for pushing the submerged nozzle in the horizontal direction, in which: an entire width dimension of each of the first and second clampers is set to be smaller than a flange diameter dimension of a flange of the submerged nozzle; a positioning member, which is provided so as to be suspended from the supporting protrusion, is engaged to the first and second clampers so as to position each of the clampers; and a positioning liner, which is provided on a lower surface of the lower frame, guides an upper surface of a subsequent and fresh submerged nozzle replacing the submerged nozzle, to thereby regulate a height position of the fresh submerged nozzle during movement in the horizontal direction of the fresh submerged nozzle. Further, each of clamper pieces of the first and second clampers is axially supported through a pin, the positioning member passes through a through-hole formed in a rear portion of each of the clamper pieces, and an enlarged portion, which is formed at a tip of the positioning member, is engaged to the rear portion. Further, a clamper center, which indicates a width center of the entire width dimension of each of the first and second clampers, is corresponding to a flange center, which indicates a width center of the flange diameter dimension. Between the flange diameter dimension and a first arranging width measured from the clamper center up to an upstream end on an upstream side, a relation of L1:L2=1:0.2 to 0.4 is set. Further, a tip end upper portion of each of the clamper pieces of the first and second clampers is shaped into a curved-surface-shape including a predetermined arc. Further, of the respective clamper pieces of the first and second clampers, a tip end upper portion of only each of the clamper pieces located on a most deeply inserting side or tip end upper portions of all the clamper pieces are shaped into an inclined-surface-shape.

### EFFECTS OF THE INVENTION

The submerged nozzle supporting-replacing mechanism according to the present invention is structured as described above, and hence the following effects can be obtained.

That is,

in claim 1,

a submerged nozzle supporting-replacing mechanism includes: first and second clampers, which are provided on a side of a lower frame of a slide valve device controlling a flow rate of molten metal from a tundish to a mold, and are located on both sides of a submerged nozzle so as to press the submerged nozzle during casting against an upper fire-proof object; a spring provided to a supporting protrusion of the lower frame, for upwardly biasing each of the clampers; two pairs of guide rails provided to a frame on the side of the lower frame, for guiding movement in a horizontal direction of the submerged nozzle; and an extruding device for pushing the submerged nozzle in the horizontal direction, in which: an entire width dimension of each of the first and second clampers is set to be smaller than a flange diameter dimension of a flange of the submerged nozzle; a positioning member, which is provided so as to be suspended from the supporting protrusion, is engaged to the first and second clampers so as to position each of the clampers; and a positioning liner, which is provided on a lower surface of the lower frame, is brought into slide-contact with an upper surface of a subsequent and fresh submerged nozzle replacing the submerged nozzle, to thereby regulate a height position of the fresh submerged nozzle during movement in the horizontal direction of the fresh submerged nozzle. Thus, simplification and downsizing of the structure of the mechanism, cost reduction of a fire-proof object, and smooth movement of the submerged nozzle to be inserted are achieved. Further, in claim 2, each of clamper pieces of the first and second clampers is axially supported through a pin, the positioning member passes through a through-hole formed in a rear portion of each of the clamper pieces, and an enlarged portion, which is formed at a tip of the positioning member, is engaged to the rear portion. Thus, positioning of each of the clamper pieces of the clampers and pressing to the flange of the submerged nozzle are uniformly performed, and stable biasing to the submerged nozzle is possible.

Further, in claim 3, a clamper center, which indicates a width center of the entire width dimension of each of the first and second clampers, is corresponding to a flange center, which indicates a width center of the flange diameter dimension. Between the flange diameter dimension and a first arranging width measured from the clamper center up to an upstream end on an upstream side, a relation of L1:L2=1:0.2 to 0.4 is set. Thus, the fresh submerged nozzle can be smoothly inserted in below an upper fire-proof object without coming into contact with the upper fire-proof object.

Further, in claim 4, a tip end upper portion of each of the clamper pieces of the first and second clampers is shaped into a curved-surface-shape including a predetermined arc. Thus, both the submerged nozzle and the fresh submerged nozzle can be smoothly moved through the tip end upper portion of the curved-surface shape.

Further, in claim 5, of the respective clamper pieces of the first and second clampers, a tip end upper portion of only each of the clamper pieces located on a most deeply inserting side or tip end upper portions of all the clamper pieces are shaped into an inclined-surface-shape. Thus, both the submerged nozzle and the fresh submerged nozzle can be smoothly moved through the tip end upper portion of the inclined-surface shape.

In claim 6,

a submerged nozzle supporting-replacing mechanism includes: first and second clampers, which are provided on a downstream side of a stopper device controlling a flow rate of molten metal from a tundish to a mold, and are located on both sides of a submerged nozzle so as to press the submerged nozzle during casting against an upper fire-proof object; a spring provided to a supporting protrusion of the lower frame, for upwardly biasing each of the clampers; two pairs of guide rails provided to a frame on a side of the lower frame, for guiding movement in a horizontal direction of the submerged nozzle; and an extruding device for pushing the submerged nozzle in the horizontal direction, in which: an entire width dimension of each of the first and second clampers is set to be smaller than a flange diameter dimension of a flange of the submerged nozzle; a positioning member, which is provided so as to be suspended from the supporting protrusion, is engaged to the first and second clampers so as to position each of the clampers; and a positioning liner, which is provided on a lower surface of the lower frame, is brought into slide-contact with an upper surface of a subsequent and fresh submerged nozzle replacing the submerged nozzle, to thereby regulate a height position of the fresh submerged nozzle during movement in the horizontal direction of the fresh submerged nozzle. Thus, simplification and downsizing of the structure of the mechanism, cost reduction of a fire-proof object, and smooth movement of the submerged nozzle to be inserted are achieved.

Further, in claim 7, each of clamper pieces of the first and second clampers is axially supported through a pin, the positioning member passes through a through-hole formed in a rear portion of each of the clamper pieces, and an enlarged portion, which is formed at a tip of the positioning member, is engaged to the rear portion. Thus, positioning of each of the clamper pieces of the clampers and pressing to the flange of the submerged nozzle are uniformly performed, and stable biasing to the submerged nozzle is possible.

Further, in claim 8, a clamper center, which indicates a width center of the entire width dimension of each of the first and second clampers, is corresponding to a flange center, which indicates a width center of the flange diameter dimension. Between the flange diameter dimension and a first arranging width measured from the clamper center up to an upstream end on an upstream side, a relation of L1:L2=1:0.2 to 0.4 is set. Thus, the fresh submerged nozzle can be smoothly inserted in below an upper fire-proof object without coming into contact with the upper fire-proof object.

Further, in claim 9, a tip end upper portion of each of the clamper pieces of the first and second clampers is shaped into a curved-surface-shape including a predetermined arc. Thus, both the submerged nozzle and the fresh submerged nozzle can be smoothly moved through the tip end upper portion of the curved-surface shape.

Further, in claim 10, of the respective clamper pieces of the first and second clampers, a tip end upper portion of only each of the clamper pieces located on a most deeply inserting side or tip end upper portions of all the clamper pieces are shaped into an inclined-surface-shape. Thus, both the submerged nozzle and the fresh submerged nozzle can be smoothly moved through the tip end upper portion of the inclined-surface shape.

### BRIEF DESCRIPTION OF THE DRAWINGS

FIG. 1 Across-sectional view illustrating a submerged nozzle supporting-replacing mechanism according to the present invention.

FIG. 2 An explanation view illustrating a replacement-starting state of a submerged nozzle in FIG. 1.

FIG. 3 An explanation view illustrating a state in which the replacement of FIG. 2 is progressed.

FIG. 4 A side cross-sectional view of FIG. 1.

FIG. 5 A bottom view of FIG. 4.

FIG. 6 A cross-sectional view illustrating another mode of FIG. 1.

FIG. 7 An explanation view illustrating the replacement-starting state of the submerged nozzle in FIG. 6.

FIG. 8 A cross-sectional view illustrating another mode of FIG. 4.

FIG. 9 A side view illustrating a positioning member of FIG. 8.

FIG. 10 A configuration diagram illustrating another mode of FIG. 4.

FIG. 11 A bottom view of FIG. 8.

FIG. 12 A cross-sectional view illustrating a submerged nozzle supporting-replacing mechanism according to another embodiment of the present invention.

### BEST MODE FOR CARRYING OUT THE INVENTION

It is an object of the present invention to provide a submerged nozzle supporting-replacing mechanism, which is capable of regulating a position of each of clampers by a positioning member by setting each of entire width dimensions of the clampers to be smaller than a flange diameter dimension of a submerged nozzle, and is capable of achieving a simple and low-cost structure and a reduction in size and weight of a fire-proof object by regulating a height position of a fresh submerged nozzle by a positioning liner.

### EXAMPLE

Hereinafter, preferred embodiments of a submerged nozzle supporting-replacing mechanism according to the present invention are described with reference to the drawings.

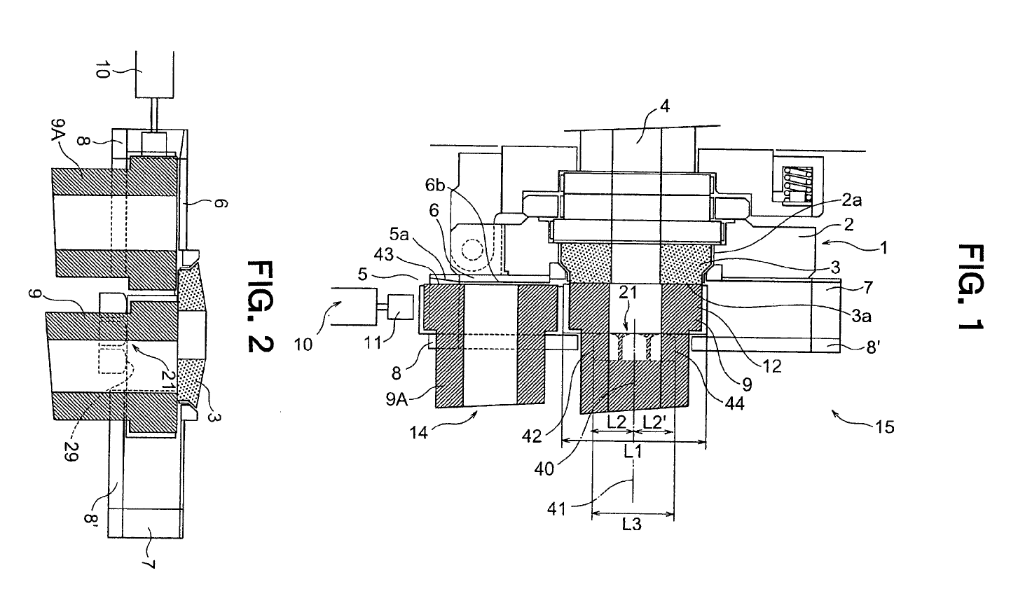

FIG. 1 illustrates a known slide valve device 1. An opening 2a is formed in a lower frame 2 of the slide valve device 1. An upper fire-proof object 3 continuous with a tapping hole 4 is provided in the opening 2a.

In a lower surface of the lower frame 2, there is provided a positioning liner 6, which includes a taper surface 5a formed to an inserting side 5. Two pairs of guide rails 8 and 8′ on the inserting side and a side opposite thereto are provided to a lower portion of a frame 7, which is formed so as to be suspended from the lower surface of the lower frame 2. In this structure, a submerged nozzle 9 and a subsequent and fresh submerged-nozzle 9A for replacement can be extruded and moved through a flange 12 by a pushing portion 11 of an extruding device 10 in a horizontal direction on each of the guide rails 8 and 8′.

In this structure, the fresh submerged-nozzle 9A is positioned at an inserting position 14, and the submerged nozzle 9 can be removed at a removing position 15. It is possible to detachably provide the extruding device 10 to the slide valve device 1 or a container for molten metal, such as a tundish (not shown). Note that, joint surfaces of upper surfaces 43 of the submerged nozzles 9 and 9A are structured so as to be equivalent in size to a lower joint surface 3a of the upper fire-proof object 3.

On a lower surface of the frame 7, there is provided a pair of first and second clampers 20 and 21. The clampers 20 and 21 are opposed to each other while sandwiching the submerged nozzle 9 along a direction orthogonal to a longitudinal direction of each of the guide rails 8 and 8′.

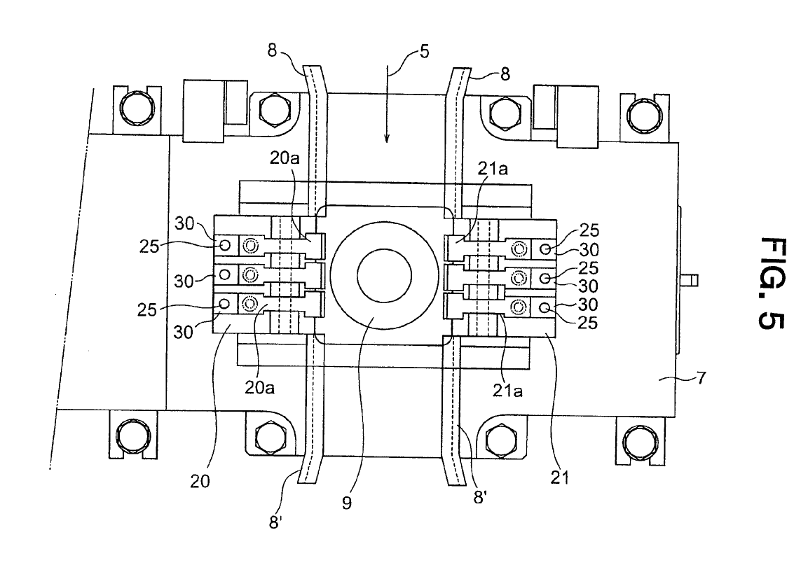

Each of the clampers 20 and 21 includes a plurality of, that is, three clamper pieces 20a and 21a which are provided in parallel to each other. As illustrated in FIG. 4, each of the clamper pieces 20a and 21a is structured such that its tip end upper portion 29 can come into contact and slide-contact with a flange lower surface 12a of the flange 12.

Each of the clamper pieces 20a and 21a is axially supported by a pin 22 supported by the lower frame 2 so that each of the clamper pieces is allowed to oscillate. Compression-type springs 24 are provided in L-shaped supporting protrusions 23, which are provided to the lower frame 2 so as to be suspended from the lower frame 2. The compression-type springs 24 push rear portions 30 of the clamper pieces 20a and 21a. Thus, the tip end upper portion 29 comes into contact with the flange lower surface 12a of the flange 12 so as to be biased. Thus, in this way, the flange 12 comes into contact with the lower joint surface 3a of the upper fire-proof object 3.

In the rear portion 30 of each of the clamper pieces 20a and 21a, there is formed a through-hole 25. A positioning member 26, which forms a stick-shape downwardly suspending from the supporting protrusion 23, passes through the through-hole 25. A flange-like enlarged portion 27, which is provided to a lower end of the positioning member 26, is located other than a lower surface of the clamper piece 21a (20a). In this way, detachment of the rear portion 30 of each of the clamper pieces 20a and 21a is prevented by the positioning member 26. Due to the enlarged portion 27, a biasing force with respect to a flange lower surface 12a during oscillating of each clamper piece 21a (20a) is restricted. That is, a stopper action is obtained in this structure.

Note that, in FIG. 4, only the second clamper 21 is illustrated in a cross-section and the first clamper 20 is omitted. However, even with regard to the first clamper 20, the same cross-sectional structure as that of FIG. 4 is constituted.

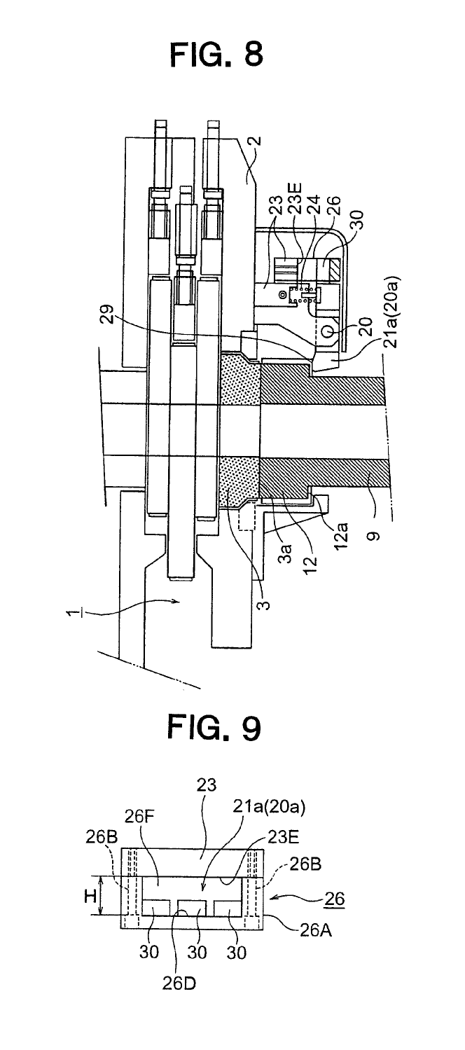

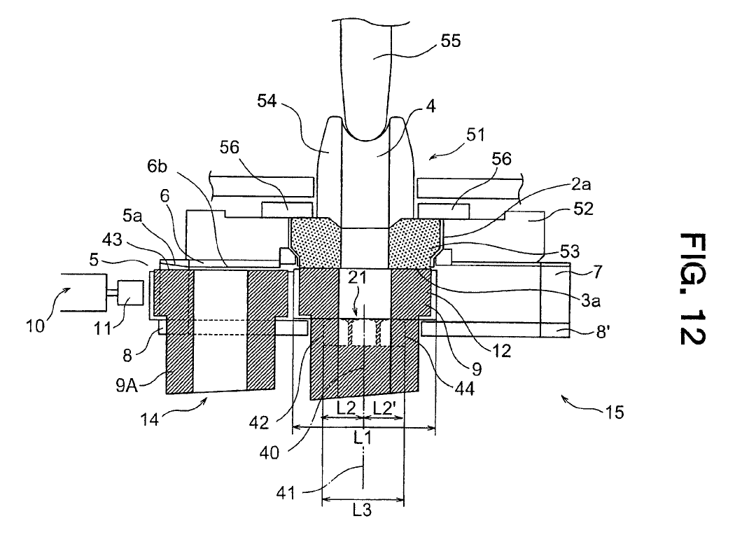

Further, an embodiment illustrated in FIG. 8 to FIG. 11 can be seen as another embodiment of the positioning member 26 and the enlarged portion 27 serving as the stopper, which are described above and are illustrated in FIG. 4 and FIG. 5.

Note that, the same portions as those in FIG. 4 and FIG. 5 are denoted by the same reference symbols, the description thereof is omitted, and only different parts are described.

That is, as illustrated in FIG. 9, the positioning member 26 includes: a recessed member 26A, which is connected to the supporting protrusion 23; and bolts 26B, with which an upper portion of the recessed member 26A is fixed so as to be put in a closed state by the supporting protrusion 23 forming an L-shape. A space 26F of a height H is formed between an inner bottom surface 26D of the recessed member 26A and a lower surface 23E of the supporting protrusion 23. Further, the positioning member 26 is formed, as in a case of FIG. 4, so as to be downwardly suspended from the supporting protrusion 23 in an integrated state with the supporting protrusion 23. Note that, in FIG. 9, though only one side is illustrated, the other side is constituted in the same manner.

In the above-mentioned structure, the respective rear portions 30 of the respective clamper pieces 21a (20a) are engaged to the positioning member 26 so as to be arranged within the space 26F. In the inner bottom surface 26D within the height H of the space 26F, regulation of rotational operation of each of the rear portions 30 is performed similarly to the above-mentioned operation of the embodiment of FIG. 4.

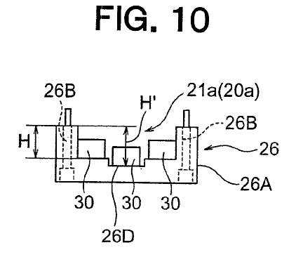

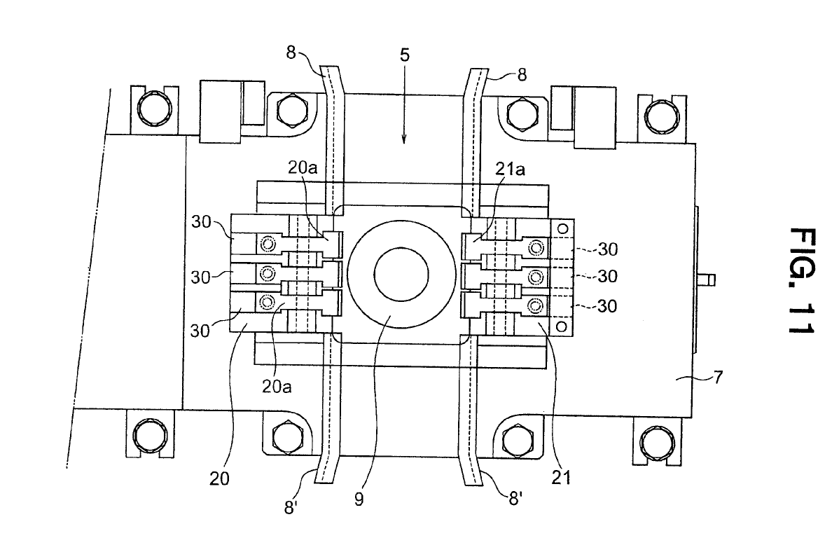

Further, FIG. 10 illustrates another embodiment of the embodiment of FIG. 9. It is possible to vary regulation within a rotation range of the clamper pieces 21a (20a) by changing the height H of a part of the inner bottom surface 26D to a height H′.

A clamper center 40 indicates a width center of each of entire width dimensions L3 of the first clamper 20 and the second clamper 21. A flange center 41 indicates a width center of a flange diameter dimension L1 of the flange 12. The clamper center 40 corresponds to the flange center 41. A first arranging width L2 indicates a width measured from the clamper center 40 toward an inserting side 5 of each of the clampers 20 and 21 up to an upstream end 42 on an upstream side. A relation between the first arranging width L2 and the flange diameter dimension L1 can be L1:L2=1:0.2 to 0.4 (note that, an optimum value is L1:L2=1:0.3), on condition that an upper surface 43 of the fresh submerged nozzle 9A, which is freshly inserted and moves, smoothly enters below the upper fire-proof object 3 without coming into contact with the upper fire-proof object 3. With regard to a second arranging width L2′ on a downstream end 44 side illustrated in FIG. 1, though it is not particularly limited, a relation of L1/2 or less is suitable. That is, with the above-mentioned structure, in a case where the fresh submerged nozzle 9A moves up to the tapping hole 4, the fresh submerged nozzle 9A is allowed to smoothly enter below the upper fire-proof object 3 without coming into contact with the upper fire-proof object 3.

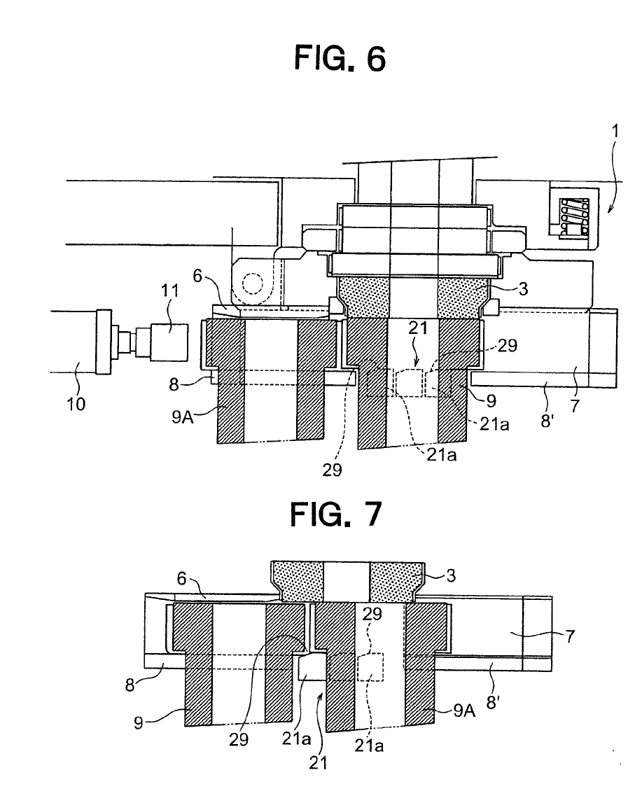

A tip end upper portion 29 of a tip of each of the clamper pieces 20a and 21a of the first and second clampers 20 and 21 is shaped into an arc-shape including a predetermined arc, that is, a curved-surface-shape, as illustrated in FIG. 2. That shape may be shaped into an inclined-surface-shape, as illustrated in FIG. 6 and FIG. 7, in which the tip end upper portion 29 of only one clamper piece 20a or 21a located on a most deeply inserting side or the tip end upper portions of all the clamper pieces 20a or 21a are formed so as to be inclined downwardly toward the inserting side 5.

Next, in the above-mentioned structure, a case of actuating the submerged nozzle supporting-replacing mechanism according to the present invention is described.

In the state of FIG. 1, the submerged nozzle 9 during casting from a tundish (not shown) and to a mold is illustrated, and the submerged nozzle 9 is upwardly biased to the lower joint surface 3a of the upper fire-proof object 3 continuous with the tapping hole 4 by each of the clampers 20 and 21.

In the above-mentioned state, in order to replace the submerged nozzle 9 with the fresh submerged nozzle 9A with respect to the upper fire-proof object 3, the following processes are performed. Specifically, the fresh submerged nozzle 9A is inserted into between the guide rails 8 and the positioning liner 6. The fresh submerged nozzle 9A is pushed by the extruding device 10 to the right in FIG. 1. Then, as illustrated in FIG. 2, the submerged nozzle 9 is pushed by the moving fresh submerged nozzle 9A so as to slide on each of the clampers 20 and 21.

The fresh submerged nozzle 9A is further pushed by the extruding device 10. Then, the submerged nozzle 9 is caused to release correspondence with the upper fire-proof object 3 and is downwardly removed at the removing position 15. Further, the fresh submerged nozzle 9A obtains the correspondence with the upper fire-proof object 3, and is upwardly pressed by each of the clampers 20 and 21. In this way, a replacement work is completed.

For the above-mentioned replacement of the submerged nozzle 9, when the fresh submerged nozzle 9A moving on the guide rails 8 moves up to the tapping hole 4 of the upper fire-proof object 3, an inner surface 6b of the positioning liner 6 is provided so as to be flush with or be positioned slightly below the lower joint surface 3a, and hence the upper surface 43 of the fresh submerged nozzle 9A does not rise over the lower joint surface 3a of the upper fire-proof object 3. Thus, it is possible to perform a nozzle replacement in a state in which damages and the like are prevented from occurring in the upper surface 43 of the fresh submerged nozzle 9A.

Further, for the above-mentioned replacement of the submerged nozzle 9, the tip end upper portion 29 of each of the clamper pieces 20a and 21a of the clampers 20 and 21 is shaped into the curved-surface-shape of the arc-shape or the inclined-surface-shape. As described above, arranging relation among the entire width dimension L3 of each of the clampers 20 and 21, the first arranging width L2, and the flange diameter dimension L1 of the submerged nozzle 9 is set, and hence the fresh submerged nozzle 9A is allowed to smoothly enter below the upper fire-proof object 3 without coming into contact with the upper fire-proof object 3.

Further, FIG. 12 illustrates another embodiment of FIG. 1 of the present invention. In this structure, the slide valve device 1 of FIG. 1 is substituted by, for example, a known stopper device 51 described in Japanese Patent Application Laid-open No. Hei 5-200504 or the like. Only a structure different from that of FIG. 1 is described, the same portions as those in FIG. 1 are denoted by the same reference symbols, and the description thereof is omitted.

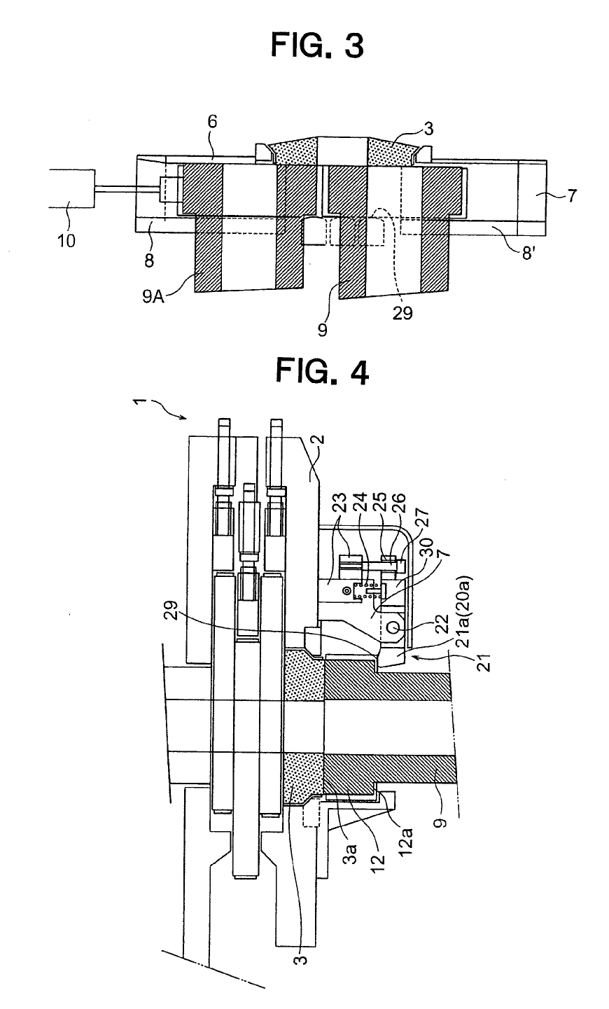

Note that, also with regard to FIG. 2 to FIG. 11, the structure of FIG. 2 to FIG. 11 is completely identical other than a structure in which the slide valve device 1 is substituted by the stopper device 51 as in FIG. 12, and hence the structure of FIG. 2 to FIG. 11 is employed here.

In FIG. 12, the stopper device 51 includes an upper nozzle 54 and a stick-like stopper 55. The upper nozzle 54 is provided on an upper fire-proof object 53 retained by a lower frame 52 and includes the tapping hole 4 formed therein. The stick-like stopper 55 can be inserted in and extracted from the tapping hole 4 of the upper nozzle 54 so as to allow the tapping hole 4 to be opened and closed to control a flow rate of molten metal. The upper fire-proof object 53 is downwardly biased by a ring body 56 provided on the upper surface of the lower frame 52.

Note that, on a downstream side of the stopper device 51 for controlling a flow rate of molten metal from the tundish (not shown) to the mold, the first clamper 20, the second clamper 21, and the like for supporting and replacing the submerged nozzle 9 are constituted as illustrated in FIG. 2 and FIG. 2 to FIG. 11 described above. With regard to replacing operation of the submerged nozzle 9, its structure is the same as the structure illustrated in FIG. 2 to FIG. 11 described above. Therefore, for the description of its operation, the above-mentioned description is employed here, and the repeated description is omitted.

1. A submerged nozzle supporting-replacing mechanism, comprising:
first and second clampers (20 and 21), which are provided on a side of a lower frame (2) of a slide valve device (1) controlling a flow rate of molten metal from a tundish to a mold, and are located on both sides of a submerged nozzle (9) so as to press the submerged nozzle (9) during casting against an upper fire-proof object (3);
a spring (24) provided to a supporting protrusion (23) of the lower frame (2), for upwardly biasing each of the clampers (20 and 21);
two pairs of guide rails (8 and 8′) provided to a frame (7) on the side of the lower frame (2), for guiding movement in a horizontal direction of the submerged nozzle (9); and
an extruding device (10) for pushing the submerged nozzle (9) in the horizontal direction, wherein:
an entire width dimension (L3) of each of the first and second clampers (20 and 21) is set to be smaller than a flange diameter dimension (L1) of a flange (12) of the submerged nozzle (9);
a positioning member (26), which is provided so as to be suspended from the supporting protrusion (23), is engaged to the first and second clampers (20 and 21) so as to position each of the dampers (20 and 21); and
a positioning liner (6), which is provided on a lower surface of the lower frame (2), guides an upper surface (43) of a subsequent and fresh submerged nozzle (9A) replacing the submerged nozzle (9), to thereby regulate a height position of the fresh submerged nozzle (9A) during movement in the horizontal direction of the fresh submerged nozzle (9A).

2. A submerged nozzle supporting-replacing mechanism according to claim 1, wherein:
each of clamper pieces (20a and 21a) of the first and second dampers (20 and 21) is axially supported through a pin (22);
the positioning member (26) passes through a through-hole (25) formed in a rear portion (30) of each of the clamper pieces (20a and 21a); and
an enlarged portion (27), which is formed at a tip of the positioning member (26), is engaged to the rear portion (30).

3. A submerged nozzle supporting-replacing mechanism according to claim 1, wherein:
a damper center (40), which indicates a width center of the entire width dimension (L3) of each of the first and second clampers (20 and 21), is corresponding to a flange center (41), which indicates a width center of the flange diameter dimension (L1); and
between the flange diameter dimension (L1) and a first arranging width (L2) measured from the clamper center (40) up to an upstream end (42) on an upstream side, a relation of L1:L2=1:0.2 to 0.4 is set.

4. A submerged nozzle supporting-replacing mechanism according to claim 1, wherein a tip end upper portion (29) of each of the clamper pieces (20a and 21a) of the first and second clampers (20 and 21) is shaped into a curved-surface-shape including a predetermined arc.

5. A submerged nozzle supporting-replacing mechanism according to claim 1, wherein, of the respective clamper pieces (20a and 21a) of the first and second clampers (20 and 21), a tip end upper portion (29) of only each of the clamper pieces (20a and 21a) located on a most deeply inserting side (5) or tip end upper portions of all the damper pieces (20a and 21a) are shaped into an inclined-surface-shape.

6. A submerged nozzle supporting-replacing mechanism, comprising:
first and second clampers (20 and 21), which are provided on a downstream side of a stopper device (51) controlling a flow rate of molten metal from a tundish to a mold, and are located on both sides of a submerged nozzle (9) so as to press the submerged nozzle (9) during casting against an upper fire-proof object (3);
a spring (24) provided to a supporting protrusion (23) of the lower frame (2), for upwardly biasing each of the clampers (20 and 21);
two pairs of guide rails (8 and 8′) provided to a frame (7) on a side of the lower frame (2), for guiding movement in a horizontal direction of the submerged nozzle (9); and
an extruding device (10) for pushing the submerged nozzle (9) in the horizontal direction, wherein:
an entire width dimension (L3) of each of the first and second clampers (20 and 21) is set to be smaller than a flange diameter dimension (L1) of a flange (12) of the submerged nozzle (9);
a positioning member (26), which is provided so as to be suspended from the supporting protrusion (23), is engaged to the first and second clampers (20 and 21) so as to position each of the dampers (20 and 21); and
a positioning liner (6), which is provided on a lower surface of the lower frame (2), guides an upper surface (43) of a subsequent and fresh submerged nozzle (9A) replacing the submerged nozzle (9), to thereby regulate a height position of the fresh submerged nozzle (9A) during movement in the horizontal direction of the fresh submerged nozzle (9A).

7. A submerged nozzle supporting-replacing mechanism according to claim 6, wherein:
each of clamper pieces (20a and 21a) of the first and second clampers (20 and 21) is axially supported through a pin (22);
the positioning member (26) passes through a through-hole (25) formed in a rear portion (30) of each of the clamper pieces (20a and 21a); and
an enlarged portion (27), which is formed at a tip of the positioning member (26), is engaged to the rear portion (30).

8. A submerged nozzle supporting-replacing mechanism according to claim 6, wherein:
a damper center (40), which indicates a width center of the entire width dimension (L3) of each of the first and second clampers (20 and 21), is corresponding to a flange center (41), which indicates a width center of the flange diameter dimension (L1); and
between the flange diameter dimension (L1) and a first arranging width (L2) measured from the clamper center (40) up to an upstream end (42) on an upstream side, a relation of L1:L2=1:0.2 to 0.4 is set.

9. A submerged nozzle supporting-replacing mechanism according to claim 6, wherein a tip end upper portion (29) of each of the clamper pieces (20a and 21a) of the first and second clampers (20 and 21) is shaped into a curved-surface-shape including a predetermined arc.

10. A submerged nozzle supporting-replacing mechanism according to claim 6, wherein, of the respective clamper pieces (20a and 21a) of the first and second clampers (20 and 21), a tip end upper portion (29) of only each of the clamper pieces (20a and 21a) located on a most deeply inserting side (5) or tip end upper portions of all the damper pieces (20a and 21a) are shaped into an inclined-surface-shape.

11. A submerged nozzle supporting-replacing mechanism according to claim 2, wherein:
a damper center (40), which indicates a width center of the entire width dimension (L3) of each of the first and second clampers (20 and 21), is corresponding to a flange center (41), which indicates a width center of the flange diameter dimension (L1); and
between the flange diameter dimension (L1) and a first arranging width (L2) measured from the clamper center (40) up to an upstream end (42) on an upstream side, a relation of L1:L2=1:0.2 to 0.4 is set.

12. A submerged nozzle supporting-replacing mechanism according to claim 2, wherein a tip end upper portion (29) of each of the clamper pieces (20a and 21a) of the first and second clampers (20 and 21) is shaped into a curved-surface-shape including a predetermined arc.

13. A submerged nozzle supporting-replacing mechanism according to claim 3, wherein a tip end upper portion (29) of each of the clamper pieces (20a and 21a) of the first and second clampers (20 and 21) is shaped into a curved-surface-shape including a predetermined arc.

14. A submerged nozzle supporting-replacing mechanism according to claim 2, wherein, of the respective clamper pieces (20a and 21a) of the first and second clampers (20 and 21), a tip end upper portion (29) of only each of the clamper pieces (20a and 21a) located on a most deeply inserting side (5) or tip end upper portions of all the clamper pieces (20a and 21a) are shaped into an inclined-surface-shape.

15. A submerged nozzle supporting-replacing mechanism according to claim 3, wherein, of the respective clamper pieces (20a and 21a) of the first and second clampers (20 and 21), a tip end upper portion (29) of only each of the clamper pieces (20a and 21a) located on a most deeply inserting side (5) or tip end upper portions of all the clamper pieces (20a and 21a) are shaped into an inclined-surface-shape.

16. A submerged nozzle supporting-replacing mechanism according to claim 7, wherein:
a damper center (40), which indicates a width center of the entire width dimension (L3) of each of the first and second clampers (20 and 21), is corresponding to a flange center (41), which indicates a width center of the flange diameter dimension (L1); and
between the flange diameter dimension (L1) and a first arranging width (L2) measured from the clamper center (40) up to an upstream end (42) on an upstream side, a relation of L1:L2=1:0.2 to 0.4 is set.

17. A submerged nozzle supporting-replacing mechanism according to claim 7, wherein a tip end upper portion (29) of each of the clamper pieces (20a and 21a) of the first and second clampers (20 and 21) is shaped into a curved-surface-shape including a predetermined arc.

18. A submerged nozzle supporting-replacing mechanism according to claim 8, wherein a tip end upper portion (29) of each of the clamper pieces (20a and 21a) of the first and second clampers (20 and 21) is shaped into a curved-surface-shape including a predetermined arc.

19. A submerged nozzle supporting-replacing mechanism according to claim 7, wherein, of the respective clamper pieces (20a and 21a) of the first and second clampers (20 and 21), a tip end upper portion (29) of only each of the clamper pieces (20a and 21a) located on a most deeply inserting side (5) or tip end upper portions of all the damper pieces (20a and 21a) are shaped into an inclined-surface-shape.

20. A submerged nozzle supporting-replacing mechanism according to claim 8, wherein, of the respective clamper pieces (20a and 21a) of the first and second clampers (20 and 21), a tip end upper portion (29) of only each of the clamper pieces (20a and 21a) located on a most deeply inserting side (5) or tip end upper portions of all the damper pieces (20a and 21a) are shaped into an inclined-surface-shape.
